(19) United States
(12) Patent Application Publication
(10) Pub. No.: US 2024/0118692 A1
(43) Pub. Date: Apr. 11, 2024

(54) SYSTEM AND METHOD FOR PREFORMING LIVE MIGRATION FROM A SOURCE HOST TO A TARGET HOST

(71) Applicant: Denso Corporation, Kariya-City (JP)

(72) Inventors: Ameer Kashani, Southfield, MI (US); Carlos Mora-Golding, Southfield, MI (US)

(21) Appl. No.: 17/960,403

(22) Filed: Oct. 5, 2022

(51) Int. Cl. G05D 1/00; G06F 9/455

(52) U.S. Cl. CPC G05D 1/0055; G06F 9/45558; G06F 2009/45562; G06F 2009/4557

(57) ABSTRACT

Disclosed herein are systems and methods for performing live migration from a source host to a target host. In one example, a processor of the system is configured to determine workload data for active workloads utilizing the source host and available live migration candidate hosts and select the target host from the live migration candidate hosts based on the workload requirement information and configuration data of the live migration candidate hosts. Once selected, the system will determine and execute a migration routine for migrating the active workloads from the source host to the target host.

### TECHNICAL FIELD

The subject matter described herein relates, in general, to systems and methods for performing live migration from a source host to a target host and, more specifically, systems and methods for performing live migration where the source host and the target host are located within a vehicle and/or are embedded systems.

### BACKGROUND

The background description provided is to present the context of the disclosure generally. Work of the inventor, to the extent it may be described in this background section, and aspects of the description that may not otherwise qualify as prior art at the time of filing are neither expressly nor impliedly admitted as prior art against the present technology.

Live migration is the process of transferring a live virtual machine from one physical host to another without disrupting its normal operation. Live migration enables the porting of virtual machines and is carried out systematically to ensure minimal operational downtime. In some cases, live migration may be performed when a host or application executed by the host needs maintenance, updating, and the like.

In one example of live migration, data stored in the memory of a virtual machine is transferred to the target host. Once the memory copying process is complete, an operational resource state consisting of a processor, memory, and storage is created on the target host. After that, the virtual machine is suspended on the original host and copied and initiated on the target host and its installed applications. Generally, this process has minimal downtime making it the process of choice for updating servers, such as web-based servers, which require the minimization of disruptions.

Live migration performed on servers is usually fairly straightforward, as the host server and the target server usually have the same hardware configurations with the same inputs and outputs (e.g., ethernet-based connectivity). Embedded systems, such as those typically found in vehicles, pose unique challenges when performing upgrades. Moreover, different embedded systems may have different requirements, such as different safety integrity levels, processor extension requirements, and/or different input/output requirements. For example, one embedded system may not be able to be utilized as a target host for another embedded system when performing live migration because the embedded system may not have the appropriate safety integrity levels, processor extension requirements, and/or appropriate input/output requirements.

### SUMMARY

This section generally summarizes the disclosure and is not a comprehensive explanation of its full scope or all its features.

In one embodiment, a system for performing live migration from a source host to a target host includes a processor and a memory in communication with the processor storing instructions. When executed by the processor, the instructions cause the processor to determine workload data for active workloads utilizing the source host. In one example, the workload data includes workload requirement information indicating hardware support requirements for executing the active workloads, such as safety integrity level, processor extension type, and/or input/output mapping information.

Next, the instructions cause the processor to determine available live migration candidate hosts and select the target host from the live migration candidate hosts based on the workload requirement information for the active workloads and configuration data of the live migration candidate hosts. Once selected, the instructions cause the processor to determine and perform a migration routine for migrating the active workloads from the source host to the target host.

In another embodiment, a method for performing live migration from a source host to a target host includes the step of determining workload data for active workloads utilizing the source host. Like before, the workload data includes workload requirement information indicating hardware support requirements for executing the active workloads, such as safety integrity level, processor extension type, and/or input/output mapping information. The method further includes the steps of determining available live migration candidate hosts and selecting the target host from the live migration candidate hosts based on the workload requirement information for the active workloads and configuration data of the live migration candidate hosts. Once selected, the method determines and performs a migration routine for migrating the active workloads from the source host to the target host.

In yet another embodiment, a non-transitory computer readable medium includes instructions that, when executed by a processor, cause the processor to determine workload data for active workloads utilizing the source host. Again, like before, the workload data includes workload requirement information indicating hardware support requirements for executing the active workloads, such as safety integrity level, processor extension type, and/or input/output mapping information.

Next, the instructions cause the processor to determine available live migration candidate hosts and select the target host from the live migration candidate hosts based on the workload requirement information for the active workloads and configuration data of the live migration candidate hosts. Once selected, the instructions cause the processor to determine and perform a migration routine for migrating the active workloads from the source host to the target host.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a vehicle incorporating a system for performing live migration from a source host to a target host.

FIG. 2 illustrates a more detailed view of the vehicle of FIG. 1.

FIG. 3 illustrates one example of a host for performing live migration.

FIG. 4 illustrates one example of workload data for active workloads utilizing a host.

FIG. 5 illustrates one example of configuration data from available live migration candidate hosts.

FIG. 6 illustrates a block diagram of performing live migration from a source host to a target host.

FIG. 7 illustrates one example of a method for performing live migration from a source host to a target host.

FIG. 8 illustrates one example of performing a migration routine.

### DETAILED DESCRIPTION

Described herein are systems and methods for performing live migration between a source host and a target host. Performing live migration for embedded systems, especially those found in automobiles, poses unique challenges not found in more traditional live migration techniques for server-based live migration. Moreover, embedded systems typically have different types of processors with different extensions and safety integrity levels. Furthermore, these embedded systems typically have input/outputs (I/O) that may vary from embedded system to embedded system. These differences complicate live migration between different embedded systems.

The systems and methods described herein determine workload data for active workloads that utilize the source host. Workload data includes information indicating hardware support requirements for executing the active loads, such as safety integrity level, instructions set, the number of cores, processor extensions, I/O mapping information, and other information. The systems and methods also identify live migration candidate hosts and receive configuration data from these candidate hosts that indicate performance features of the candidate hosts. The configuration data may contain information similar to the workload data indicating the safety integrity level, instruction set, number of cores, processor extensions, I/O mapping information, etc., for each candidate host.

Based on the configuration data and the workload data, a target host is selected from the candidate hosts. Once the target host is selected, a migration routine for migrating the active workloads from the source host to the target host is prepared and performed. In some cases where the source host and the target host have uncommon I/O terminations, tunneling agents may operate on the source host and the target host to allow the target host to still access the uncommon I/O by the source host.

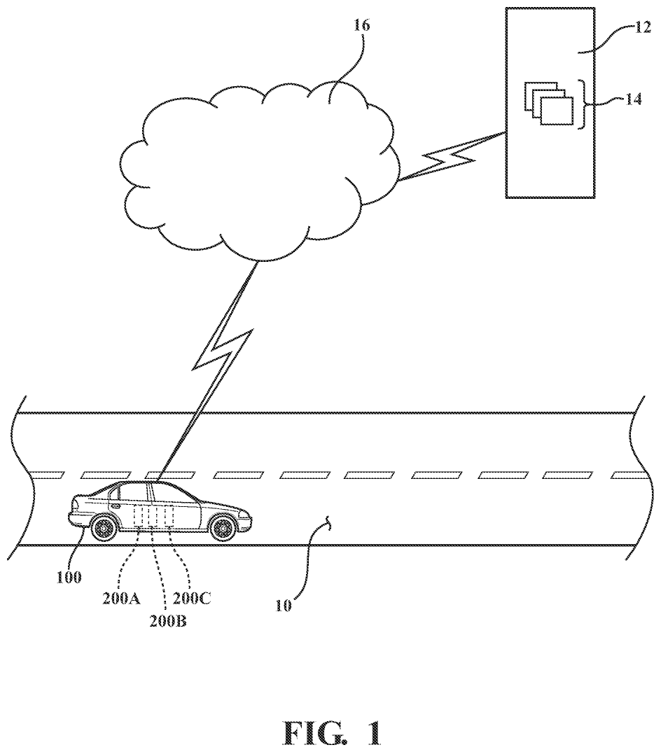

Referring to FIG. 1, illustrated is one example of a vehicle 100 traveling on a road 10. The vehicle 100 includes hosts 200A-200C. As will be explained in greater detail later, the hosts 200A-200C are computers or other devices that can communicate with each other and/or other hosts on the network. The hosts 200A-200C may provide computational and storage capabilities to support one or more applications that are utilizing the computational resources of the hosts 200A-200C.

The hosts 200A-200C may provide computational support for executing applications that provide numerous functionalities for the vehicle 100. For example, the hosts 200A-200C may help execute applications related to vehicle safety, entertainment, propulsion systems, and the like. In this example, the hosts 200A-200C may be mounted within the vehicle 100 and may be one or more embedded systems. Also, it should be understood that while the vehicle 100 is shown to only have three hosts 200A-200C, the vehicle 100 may have any number of hosts.

Situations may arise where applications being executed by the hosts 200A-200C may need to be migrated. In some cases, the migration may be due to implementing updates, improving security, functionality, or other features of the applications being executed by the hosts 200A-200C. The hosts 200A-200C may apply the migration in response to scheduled upgrades or judgment of misbehavior, including, but not limited to, dynamically detected risks, performance degradations, alerts from monitoring mechanisms (e.g., intrusion detection systems, firewalls, anti-exploitation/anti-tampering, etc.), loss of system/safety integrity, failures due to natural causes (e.g., component aging, electromagnetic interference, etc.) or failures due to manmade causes (e.g., physical damage, cyberattacks, etc.). For example, a cloud-based server 12 may include one or more upgrades 14 that may be communicated to the vehicle 100 via a network 16. In some situations, a host can be taken offline, and an upgrade of the applications can be performed. However, in other situations, such as those mentioned previously, taking the host offline may not be possible. In those situations, as will be explained in greater detail later, live migration may be performed, which involves moving a virtual machine (VM) running on a source host to a target host without disrupting normal operations or causing any downtime or other adverse effects for the end user.

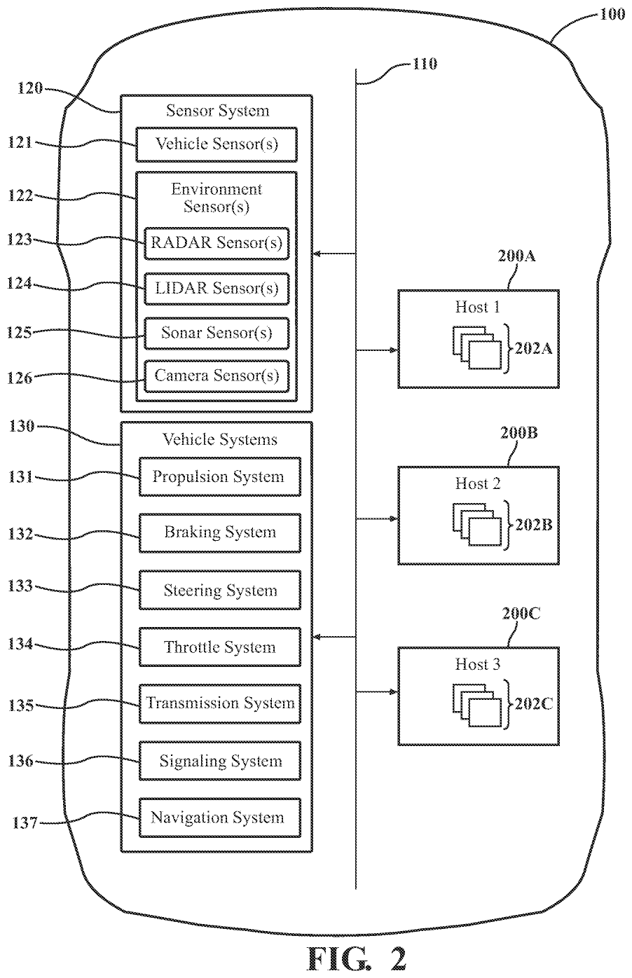

Referring to FIG. 2, illustrated is a block diagram of the vehicle 100. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport. Additionally, it should be understood that the live migration systems and methods described in this disclosure can be applied to non-vehicle-type applications, especially applications with embedded systems.

The vehicle 100 also includes various elements. It will be understood that in various embodiments it may not be necessary for the vehicle 100 to have all of the elements shown in FIG. 2. The vehicle 100 can have any combination of the various elements shown in FIG. 2. Further, the vehicle 100 can have additional elements to those shown in FIG. 2. In some arrangements, the vehicle 100 may be implemented without one or more of the elements shown in FIG. 2. While the various elements are shown as being located within the vehicle 100 in FIG. 2, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 2 and will be described along with subsequent figures. However, a description of many of the elements in FIG. 2 will be provided after the discussion of FIGS. 2-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100, as explained previously, includes hosts 200A-200C that provide the hardware resources (computational, storage, connectivity, or otherwise, to execute various applications that enable features of the vehicle 100. For example, the host 200A may execute applications 202A that provide safety-related features, such as lane departure warning, lane keep assist, emergency braking, semi-autonomous and/or autonomous driving capabilities, antilock braking, and the like. For example, the applications 202A executed by the host 200A may receive information from the sensor system 120, determine a response plan, and activate the vehicle systems 130. The hosts 200B and/or 200C provide hardware resources for applications 202B and 202C, respectively, that may provide overlapping or other vehicle functions, such as occupant entertainment, engine/transmission/propulsion management, and the like.

The hosts 200A-200C may communicate with each other and/or other various vehicle systems using a bus 110. In addition to the bus 110, the hosts 200A-200C may also use other I/O communication methodologies that may be uncommon to each other. For example, the hosts 200A and 200B may have a common I/O with the bus 110 but may also have uncommon I/O that are not shared. In these situations, as will be explained later, tunneling agents may be utilized to provide access to uncommon I/O.

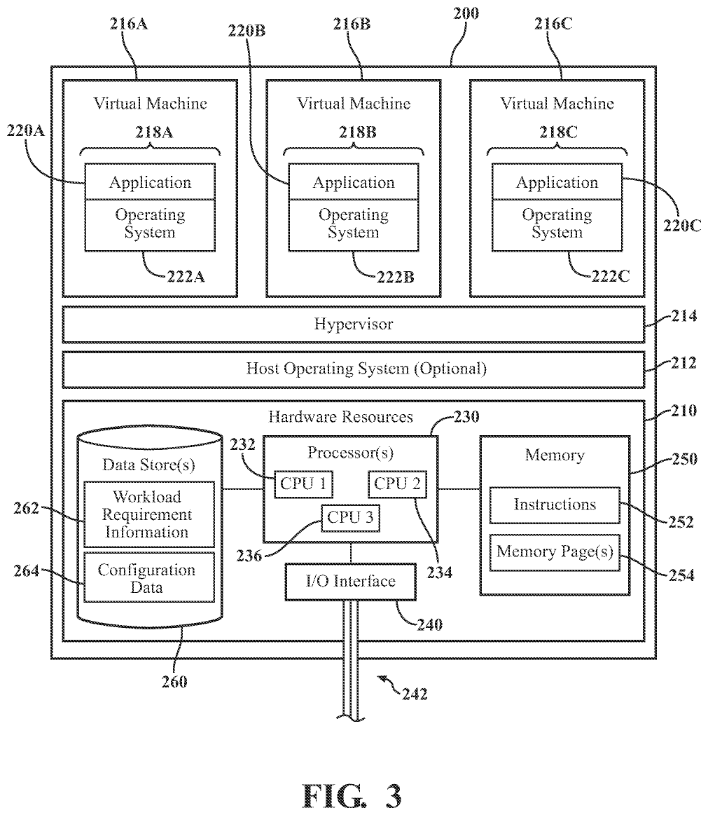

An example of a host 200, which may be similar to the host 200A-200B, is shown in FIG. 3. As its primary components, the host 200 may include hardware resources 210, an operating system 212, a hypervisor 214, and virtual machines 216A-216C. The hardware resources 210 provide the appropriate hardware for the operation of the operating system 212 and the hypervisor 214. It should be understood that the host operating system 212 may be optional. For example, if the hypervisor 214 is a Type 1 hypervisor, then the operating system 212 may not be present. Conversely, if the hypervisor 214 is a Type 2 hypervisor, then the operating system 212 may be present. More specifically, Type 1 hypervisors, called native or bare-metal hypervisors, run directly on the hardware resources 210 of the host 200. Type 2 hypervisors, sometimes called hosted hypervisors, run on a conventional operating system, such as the operating system 212.

The hardware resources 210 can vary from host to host. In this example, the hardware resources 210 include one or more processor(s) 230. In this example, the processor(s) 230 include three processors 232-236. It should be understood that the hardware resources 210 can include any one of a number of different processors. Furthermore, the processors 232-236 may be substantially similar to each other or may be different from each other. For example, the processor 232 may have a different safety integrity level, different instruction set, and/or different processor extensions than that of the processor 234. Similarly, the processor 236 may be the same or different from the processor 232 and/or 234. The one or more processor(s) 230 may be a part of the host 200 or the host 200 may access the processor(s) 230 through a data bus or another communication path. In one or more embodiments, the processor(s) 230 is an application-specific integrated circuit that is capable of performing various functions as described herein.

The hardware resources 210 may include an I/O interface 240 that is in communication with the processor(s) 230. The I/O interface 240 may include any necessary hardware and/or software for allowing the host 200 to communicate with other devices via connection 242. The connections 242 may be common, uncommon, or a combination thereof in relation to other hosts. For example, referring to the example in FIG. 2, the host 200A may be able to communicate with one set of systems and subsystems of the vehicle 100. In contrast, the host 200B may be able to communicate with another set of systems and subsystems of the vehicle 100. Further still, some systems and subsystems of the vehicle 100 may communicate with hosts 200A and 200B.

The hardware resources 210 can also include a memory 250 that stores instructions 252 and/or the memory pages 254 used by the virtual machines 216A-216C and workloads 218A-218C. The memory 250 may be a random-access memory (RAM), read-only memory (ROM), a hard disk drive, a flash memory, or other suitable memory for storing the instructions 252 and/or the memory pages 254. The instructions 252 are, for example, computer-readable instructions that, when executed by the processor(s) 230, cause the processor(s) 230 to perform the various functions disclosed herein. The memory pages 254 may be a fixed-length contiguous block of virtual memory, described by a single entry in a page table.

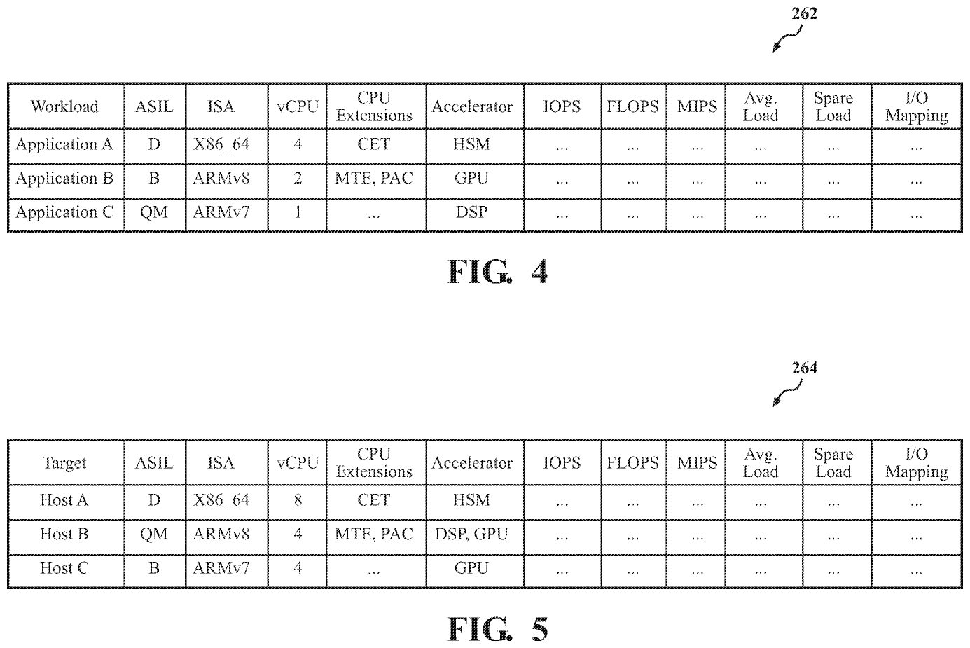

Furthermore, in one embodiment, hardware resources 210 include one or more data store(s) 260. The data store(s) 260 is, in one embodiment, an electronic data structure such as a database that is stored in the memory 250 or another memory and that is configured with routines that can be executed by the processor(s) 230 for analyzing stored data, providing stored data, organizing stored data, and so on. Thus, in one embodiment, the data store(s) 260 store data used by the instructions 252 in executing various functions. In one embodiment, the data store(s) 260 includes workload requirement information 262 and configuration data 264, which will be described later in this description and shown in FIGS. 4 and 5, respectively.

Returning to the virtual machines 216A-216C, it should be understood that the host 200 can have any one of a number of different virtual machines operating thereon. In this example, each of the virtual machines 216A-216C have workloads 218A-218C being executed thereon. The virtual machines 216A-216C may be the virtualization/emulation of a computer system. The virtual machines 216A-216C may be based on computer architectures and provide the functionality of a physical computer. Their implementations may involve specialized hardware, software, or a combination.

The workloads 218A-218C may include operating systems 222A-222C that are executing applications 220A-220C, respectively. Essentially, each of the virtual machines 216A-216C are executing different applications that provide different features for the vehicle 100. For example, the application 220A associated with the workload 218A may be executing safety-related applications, such as advanced driver assistant systems (ADAS), while the application 220B associated with workload 218B may be executing entertainment-related applications. The implementation of applications 220A-220C may also be based on containerization or unikernels.

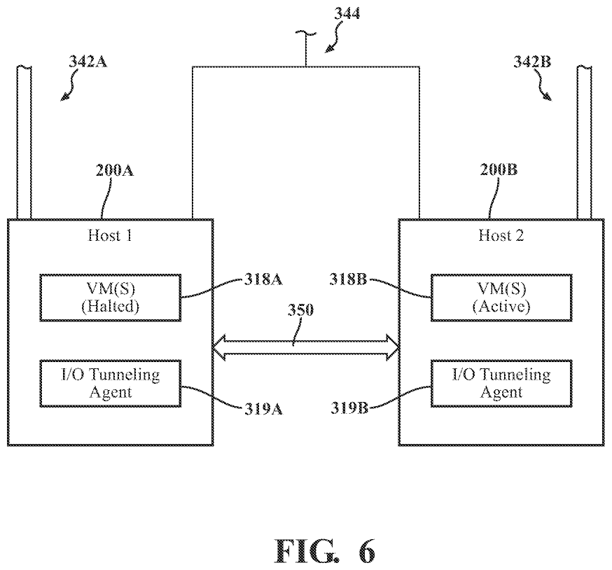

As mentioned before, the instructions 252, when executed by the processor(s) 230, can cause the processor(s) 230 to perform any of the methodologies described herein. In particular, the instructions 252 may cause the processor(s) 230 to perform live migration from a source host to a target host by considering the workload requirement information 262 and the configuration data 264. For example, referring to FIG. 6, consider the example where live migration is performed from the host 200A to the host 200B. As mentioned before, the host 200A and/or the host 200B may be similar to the host 200 shown and described in FIG. 3. In this example, the host 200A may be referred to as the source host, while the host 200B may be considered as the target host.

In this example, the instructions 252 cause the processor(s) 230 of the source host 200A (or possibly another processor and/or host altogether) to determine workload data, in the form of workload requirement information 262, for active workloads 218A-218C. The workload requirement information 262 can include information regarding the needs of the applications 220A-220C operating on the virtual machines 216A-216C. One example of the workload requirement information 262 is shown in FIG. 4.

In the example shown in FIG. 4, the workload requirement information can include information regarding the specific requirements of the applications, such as safety integrity levels (such as Automotive Safety Integrity Level (ASIL)), processor instruction set information, number of cores, different processor extension types, processor accelerators, I/O mapping information, average/spare loads, and performance information, such as instructions per second, floating-point operations per second, and I/O operations per second. Safety integrity level information, such as ASIL, may be related to a risk classification system defined by a standard. Some applications, due to their criticality, such as safety, require hardware that has higher safety integrity levels. For example, safety-related automotive systems typically require higher safety integrity levels, while entertainment-related systems may have lower requirements.

Different processor extension types are sometimes found on processors with extended instruction sets and associated architecture providing additional features/functions to a particular processor. The processor accelerator information may include information regarding the required hardware features of a host, such as the presence of a graphic processing unit, digital signal processor, hardware security module, hardware-assisted security countermeasure, cryptographic or neural network accelerator, communications module, and the like.

I/O mapping information can include information on which systems the application needs access to. For example, the application may need access to one or more systems or subsystems of the vehicle 100 and, therefore, will need access to the appropriate bus or other connections. As mentioned before, in some cases, some hosts may have common connections wherein both hosts have access to the same system or subsystem. In other cases, some hosts may have uncommon connections where only one host has access to a particular system or subsystem while the other does not.

The instructions 252 also cause the processor(s) 230 of the source host 200A (or possibly another processor and/or host altogether) to determine available live migration candidate hosts and configuration data from the available live migration candidate hosts. For example, the live migration candidate hosts can include any of the hosts 200A-200C within the vehicle 100. For example, if the source host is host 200A, the live migration candidate hosts can include the hosts 200B and 200C.

An example of configuration data 264 from live migration candidate hosts is shown in FIG. 5. Similar to the workload requirement information 262, the configuration data 264 also includes information regarding each candidate host's hardware performance features, such as safety integrity levels (such as ASIL), processor instruction set information, number of cores, different processor extension types, processor accelerators, I/O mapping information, average/spare loads, and performance information, such as instructions per second, floating-point operations per second, and I/O operations per second.

Based on the workload requirement information 262 and the configuration data 264, the instructions 252 also cause the processor(s) 230 of the source host 200A (or possibly another processor and/or host altogether) to select the target host from the live migration candidate host. In the example shown in FIG. 6, the host 200B has been selected as the target host. During live migration, the virtual machines 318A operating on the host 200A will be halted and re-created as the virtual machines 318B that will operate using the hardware of the host 200B.

To minimize disruptions and performance, the instructions 252 also cause the processor(s) 230 of the source host 200A (or possibly another processor and/or host altogether) to determine an I/O routing configuration. As mentioned before, in some cases, the source host in the target host may share the same I/O configuration and have access to the same systems and subsystems. However, in other situations, the target host may not have the appropriate I/O to access certain systems and subsystems accessible by the source host. In the example shown in FIG. 6, the hosts 200A and 200B both have common I/O 344. However, they also have uncommon I/O 342A (accessible only by the host 200A) and uncommon I/O 342B (accessible only by the host 200B).

For the host 200B to properly execute all the functions previously performed by the host 200A, the I/O routing configuration includes the ability to create tunneling agents 319A and 319B that operate on the hosts 200A and 200B, respectively. The tunneling agents 319A and 319B are essentially lightweight processes executed by the hosts 200A and 200B, respectively, allowing one host to access the uncommon I/O of the other host. In this example, the host 200B can access the uncommon I/O 342A via the tunneling agents 319A and 319B via communication path 350. The communication path 350 may be a bus directly between the hosts 200A and 200B or a shared bus utilized by other components.

The tunneling agents may reside in a region of memory that is separate from the main execution environment of the hosts 200A and 200B so that it is protected from tampering/faults (e.g., ROM, bootloader, etc.). The tunneling agents could be instructions running on a processor or an ASIC which accomplishes the functionality. As such, if an attacker triggers the live migration to occur, the tunneling will work as expected.

Once I/O tunneling has been activated, the instructions 252 cause the processor(s) 230 of the source host 200A (or possibly another processor and/or host altogether) to start transmitting associated memory pages 254 from the host 200A to the host 200B. The memory pages are utilized by the applications that will be executed by the virtual machines 318B. Once a minimum set of associated memory pages have been transferred, workloads can then be transmitted from the host 200A to the host 200B to be executed by the virtual machines 318B. The transmission of memory pages 254 continues until they have been completely transferred from the host 200A to the host 200B.

After that, the instructions 252 cause the processor(s) 230 of the source host 200A (or possibly another processor and/or host altogether) to report migration details to an incident manager and/or set a diagnostic record and enter a failsafe mode.

As such, the described system can allow live migration to be performed in embedded environments, especially in automobiles, where hosts may have different I/O mappings and hardware features. The system allows the selection of the appropriate host to act as the target host based on the configuration data of the target host and the workload requirement information of the workloads being executed by the source host. Additionally, in situations where uncommon I/O may be present, the system allows the creation of tunneling agents that allow the target host to access the uncommon I/O.

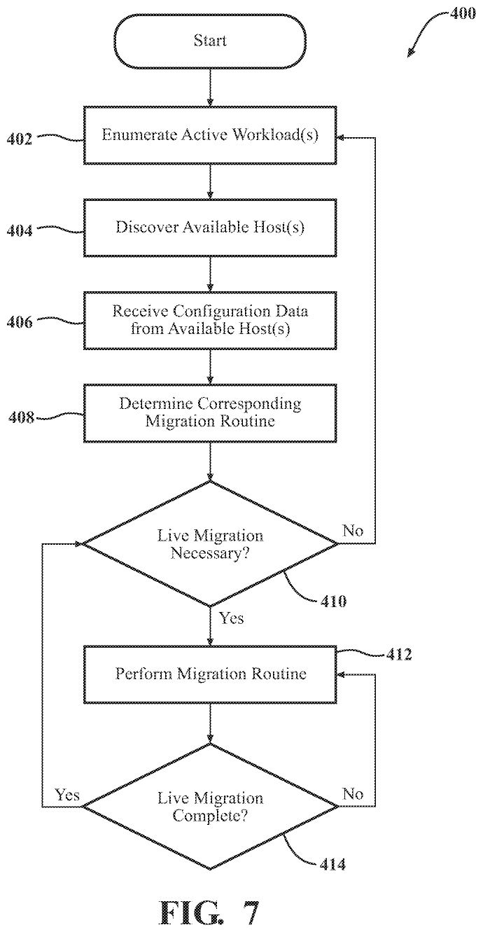

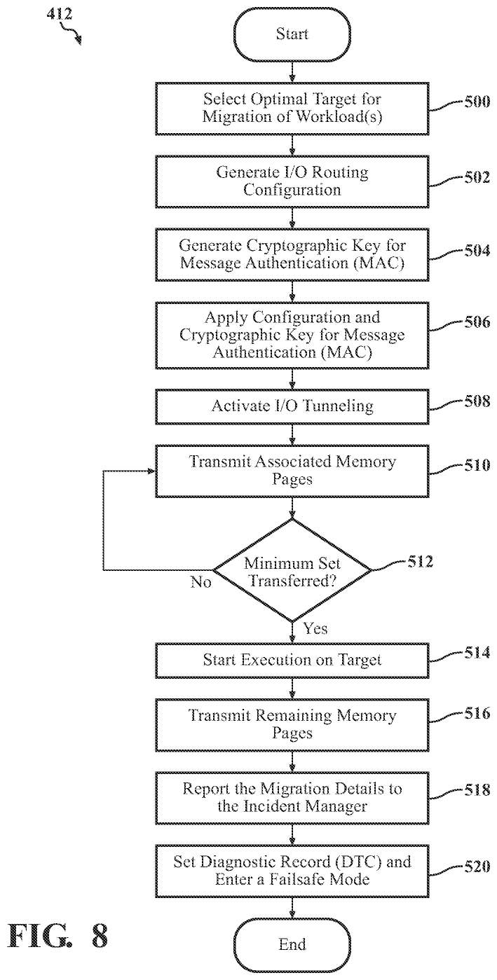

Referring to FIGS. 7 and 8, illustrated are methods for performing live migration from a source host to a target host. The methods will be described from the viewpoint of the vehicle 100 of FIG. 2 and the host 200 of FIG. 3. However, it should be understood that this is just one example of implementing the methods shown in FIGS. 7 and 8.

As mentioned before, performing live migration from a source host to a target host can be accomplished by utilizing instructions that, when executed by one or more processors, cause the execution of the methods shown in FIGS. 7 and 8. In some cases, the instructions and/or the processors utilized to perform the live migration may be found in the source host, the target host, another host that oversees the migration from the source host to the target host, or some combination.

In this example, the method 400 begins when the instructions 252 cause the processor(s) 230 to enumerate the active workloads 218A-218C that utilize the hardware resources 210 of a source host, as shown in step 402. In one example, the instructions 252 cause the processor(s) 230 of the source host 200A (or possibly another processor and/or host altogether) to determine workload data, in the form of workload requirement information 262, for active workloads 218A-218C. The workload requirement information 262 can include information regarding the needs of the applications 220A-220C operating on the virtual machines 216A-216C. As mentioned previously, one example of the workload requirement information 262 is shown in FIG. 4. As such, the workload requirement information 262 can include information such as safety integrity levels (such as Automotive Safety Integrity Level (ASIL)), processor instruction set information, number of cores, different processor extension types, processor accelerators, I/O mapping information, average/spare loads, and performance information, such as instructions per second, floating-point operations per second, and I/O operations per second. The workload requirement information 262 may also be pre-programmed (non-dynamic), or it may be cached for speedier lookups.

In step 404, the instructions 252 cause the processor(s) 230 to discover available candidate hosts. Candidate hosts are other hosts that the source host is in communication with. For example, the source host could be host 200A, and the candidate hosts could be hosts 200B and 200C. In step 406, the instructions 252 cause the processor(s) 230 to receive configuration data 264 from the available hosts. Similar to the workload requirement information 262, the configuration data 264 also includes information regarding each candidate host's hardware performance features, such as safety integrity levels (such as Automotive Safety Integrity Level (ASIL)), processor instruction set information, number of cores, different processor extension types, processor accelerators, I/O mapping information, average/spare loads, and performance information, such as instructions per second, floating-point operations per second, and I/O operations per second. As mentioned before, an example of the configuration data 264 is shown in FIG. 5. The configuration data 264 may also be pre-programmed (non-dynamic), or it may be cached for speedier lookups.

In step 408, the instructions 252 cause the processor(s) 230 to determine a corresponding migration routine. In some cases, the corresponding migration routine may not require live migration and can be performed by taking a particular host offline to perform the upgrades or other types of services. Additionally, if a suitable target host match is not found during the earlier steps, the migration routine can include actions such as reducing the connectivity or functionality of the system. This decision is made in step 410, where the instructions 252 cause the processor(s) 230 to determine if live migration is necessary or not. If live migration is unnecessary, the method 400 may return to step 402. If live migration is necessary, the method may continue to step 412, wherein the instructions 252 cause the processor(s) 230 to perform the migration routine until the live migration is complete, as indicated in step 414. After a decision at step 410, the source host may be disabled, deactivated, or otherwise restricted from influencing the general behavior of the vehicle 100. For example, the source host may be isolated from the bus 110, or certain features of the host may be deactivated. Alternatively, after reaching step 414, the source host may be terminated or continue its operation as a honeypot while detecting forensic information, such as in the case of a manmade failure (e.g., a cyberattack).

Step 412 is described in greater detail in FIG. 8. Here, in step 500, the instructions 252 cause the processor(s) 230 to select an optimal target host per migration of the workloads 218A-218C. In the example given in FIG. 6, the target host is host 200B, while the source host is host 200A. The selection of which host acts as a target host can be based on the workload requirement information 262 and the configuration data 264.

Essentially, the workload requirement information 262 lays out the requirements of the workloads 218A-218C. As mentioned before, these requirements can include things such as processor instruction type, processor extensions, I/O mapping requirements, and the like. The configuration data 264 lays out the hardware features of the candidate hosts. The candidate host that best meets the needs of the workload requirement information 262 is selected to act as the target host.

In step 502, the instructions 252 cause the processor(s) 230 to generate an I/O routing configuration so the target host can utilize the appropriate I/O. As mentioned before, there may be situations where the source host and the target host have uncommon I/O, wherein the source host may be able to access certain systems and subsystems that the target host usually cannot access. When these situations arise, tunneling agents are utilized to allow the target host to utilize the source host to access the uncommon I/O.

The exchange of information between the source host and the target host may be encrypted and/or protected from manipulation. In one example, as shown in step 504, the instructions 252 cause the processor(s) 230 to generate a cryptographic key for message authentication so that messages exchanged between the source host and the target host are protected from spoofing and/or tampering attacks. In step 506, the cryptographic key is applied. Once the message authentication (MAC) protection is initialized, the instructions 252 cause the processor(s) 230 to activate the I/O tunneling, as indicated in step 508. As best shown in FIG. 6, the tunneling agents 319A and 319B are essentially lightweight processes executed by the hosts 200A and 200B, respectively, allowing one host to access the uncommon I/O of the other host. In this example, the host 200B can access the uncommon I/O 342A via the tunneling agents 319A and 319B via communication path 350.

In step 510, the instructions 252 cause the processor(s) 230 to begin the transmission of associated memory pages from the source host to the target host. Once a minimum set is transferred, as shown in step 512, execution of the workloads 318A-318C will start on the target host, as indicated in step 514. The transmission of memory pages continues, as indicated in step 516, until all the necessary memory pages have been transferred from the source host to the target host. In some cases, there may be situations where an exception is generated when the target host does not have access to the appropriate memory page because it has not yet been transferred from the source host. When this occurs, the exception may be eventually satisfied once the appropriate memory pages have been transferred from the source host to the target host.

Once the memory pages have been transferred, the instructions 252 may cause the processor(s) 230 to report the migration details for migrating the workloads 318A-318C from the source host to the target host, as indicated in step 518. These migration details may be provided to an incident manager, which may securely log or report incidents to a manufacturer of a vehicle 100 or component of a vehicle 100. Finally, in step 520, the instructions 252 may cause the processor(s) 230 to set the diagnostic record and enter a failsafe mode.

As mentioned in the background section, traditional live migration is performed on servers that typically do not have the complexities of embedded systems, such as uncommon I/O, different processors, processor extensions, security requirements, and the like. The systems and methods described herein allow embedded systems, especially those found in automobiles, to be utilized for live migration.

FIG. 2 will now be discussed in full detail as an example environment within which the system and methods disclosed herein may operate. In one or more embodiments, the vehicle 100 may be non-autonomous, semi-autonomous, or fully autonomous. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the hosts 200A-200C or another element of the vehicle 100 (including any of the elements shown in FIG. 2). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 137, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensor(s) 121. However, it will be understood that the embodiments are not limited to the particular sensors described.

For example, in one or more arrangements, the sensor system 120 can include one or more radar sensors 123, one or more LIDAR sensors 124, one or more sonar sensors 125, and/or cameras 126. In one or more arrangements, the one or more cameras 126 can be high dynamic range (HDR) cameras or infrared (IR) cameras.

The vehicle 100 can include one or more vehicle systems 130. Various examples of the one or more vehicle systems 130 are shown in FIG. 2. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 131, a braking system 132, a steering system 133, a throttle system 134, a transmission system 135, a signaling system 136, and/or a navigation system 137. Each of these systems can include one or more devices, components, and/or a combination thereof, now known or later developed.

The navigation system 137 can include one or more devices, applications, and/or combinations thereof, now known or later developed, configured to determine the geographic location of the vehicle 100 and/or to determine a travel route for the vehicle 100. The navigation system 137 can include one or more mapping applications to determine a travel route for the vehicle 100. The navigation system 137 can include a global positioning system, a local positioning system, or a geolocation system.

The vehicle 100 can include instructions that cause one or more of the processors mounted within the vehicle 100 to perform any of the methods described herein. The instructions can be implemented as computer-readable program code that, when executed by a processor, implement one or more of the various processes described herein. The instructions can be a component of a processor and/or can be executed on and/or distributed among other processing systems.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for performing live migration from a source host to a target host, the system comprising:
a processor; and
a memory in communication with the processor and having instructions that, when executed by the processor, cause the processor to:
determine workload data for active workloads utilizing the source host, the workload data including workload requirement information indicating hardware support requirements for executing the active workloads,
determine available live migration candidate hosts and configuration data from the available live migration candidate hosts, the configuration data indicating one or more performance features of the candidate hosts,
select the target host from the live migration candidate hosts based on the workload requirement information for the active workloads utilizing the source host and the configuration data of the live migration candidate hosts,
determine a migration routine for migrating the active workloads from the source host to the target host, and
perform the migration routine to migrate the active workloads from the source host to the target host.

2. The system of claim 1, wherein the workload requirement information for the active workloads and the configuration data for the live migration candidate hosts includes at least one of a safety integrity level, a processor extension type, and an input/output mapping information.

3. The system of claim 2, wherein the memory further includes instructions that, when executed by the processor, cause the processor to select the target host from the live migration candidate hosts based on at least one of the safety integrity level, the processor extension type, and the input/output mapping information of the live migration candidate hosts.

4. The system of claim 3, wherein the memory further includes instructions that, when executed by the processor, cause the processor to select the target host from the live migration candidate hosts based on the safety integrity level, wherein the safety integrity level of the target host is greater or equal to the safety integrity level of the source host.

5. The system of claim 1, wherein the memory further includes instructions that, when executed by the processor, cause the processor to:
determine uncommon inputs/outputs, the uncommon inputs/outputs being input/outputs that are found on the source host but not on the target host; and
activate a tunneling agent on the source host to allow the target host to utilize the uncommon input/outputs via the source host.

6. The system of claim 1, wherein the memory further includes instructions that, when executed by the processor, cause the processor to:
securely transmit memory pages from the source host to the target host; and
start execution of the active workloads on the target host when a minimal set of memory pages have been transferred from the source host to the target host.

7. The system of claim 1, wherein the source host and the target host are mounted within a vehicle.

8. A method for performing live migration from a source host to a target host, the method comprising the steps of:
determining workload data for active workloads utilizing the source host, the workload data including workload requirement information indicating hardware support requirements for executing the active workloads;
determining available live migration candidate hosts and configuration data from the available live migration candidate hosts, the configuration data indicating one or more performance features of the candidate hosts;
selecting the target host from the live migration candidate hosts based on the workload requirement information for the active workloads utilizing the source host and the configuration data of the live migration candidate hosts;
determining a migration routine for migrating the active workloads from the source host to the target host; and
performing the migration routine to migrate the active workloads from the source host to the target host.

9. The method of claim 8, wherein the workload requirement information for the active workloads and the configuration data for the live migration candidate hosts includes at least one of a safety integrity level, a processor extension type, and an input/output mapping information.

10. The method of claim 9, further comprising the step of selecting the target host from the live migration candidate hosts based on at least one of the safety integrity level, the processor extension type, and the input/output mapping information of the live migration candidate hosts.

11. The method of claim 10, further comprising the step of selecting the target host from the live migration candidate hosts based on the safety integrity level, wherein the safety integrity level of the target host is greater or equal to the safety integrity level of the source host.

12. The method of claim 8, wherein the step of performing the migration routine includes the steps of:
determining uncommon input/outputs, the uncommon input/outputs being input/outputs that are found on the source host but not on the target host; and
activating a tunneling agent on the source host to allow the target host to utilize the uncommon input/outputs via the source host.

13. The method of claim 8, wherein the step of performing the migration routine includes the steps of:
securely transmitting memory pages from the source host to the target host; and
starting execution of the active workloads on the target host when a minimal set of memory pages have been transferred from the source host to the target host.

14. The method of claim 8, wherein the source host and the target host are mounted within a vehicle.

15. A non-transitory computer readable medium including instructions that, when executed by a processor, cause the processor to:
determine workload data for active workloads utilizing a source host, the workload data including workload requirement information indicating hardware support requirements for executing the active workloads;
determine available live migration candidate hosts and configuration data from the available live migration candidate hosts, the configuration data indicating one or more performance features of the candidate hosts;
select a target host from the live migration candidate hosts based on the workload requirement information for the active workloads utilizing the source host and the configuration data of the live migration candidate hosts;
determine a migration routine for migrating the active workloads from the source host to the target host; and
perform the migration routine to migrate the active workloads from the source host to the target host.

16. The non-transitory computer readable medium of claim 15, wherein the workload requirement information for the active workloads and the configuration data for the live migration candidate hosts includes at least one of a safety integrity level, a processor extension type, and an input/output mapping information.

17. The non-transitory computer readable medium of claim 16, further comprising instructions that, when executed by the processor, cause the processor to select the target host from the live migration candidate hosts based on at least one of the safety integrity level, the processor extension type, and the input/output mapping information of the live migration candidate hosts.

18. The non-transitory computer readable medium of claim 17, further comprising instructions that, when executed by the processor, cause the processor to select the target host from the live migration candidate hosts based on the safety integrity level, wherein the safety integrity level of the target host is greater or equal to the safety integrity level of the source host.

19. The non-transitory computer readable medium of claim 15, further comprising instructions that, when executed by the processor, cause the processor to:
determine uncommon input/outputs, the uncommon input/outputs being input/outputs that are found on the source host but not on the target host; and
activate a tunneling agent on the source host to allow the target host to utilize the uncommon input/outputs via the source host.

20. The non-transitory computer readable medium of claim 15, further comprising instructions that, when executed by the processor, cause the processor to:
securely transmit memory pages from the source host to the target host; and
start execution of the active workloads on the target host when a minimal set of memory pages have been transferred from the source host to the target host.
